(19) United States
(12) Patent Application Publication
(10) Pub. No.: US 2012/0256878 A1
(43) Pub. Date: Oct. 11, 2012

(54) CAPACITIVE TOUCH SENSOR, ELECTRONIC DEVICE, AND METHOD OF MANUFACTURING TRANSPARENT CONDUCTIVE-FILM LAMINATE

(75) Inventors: Takao Hashimoto, Kyoto-shi (JP); Kazuhiko Takahata, Kyoto-shi (JP); Fujio Mori, Kyoto-shi (JP)

(73) Assignee: NISSHA PRINTING CO., LTD., Kyoto-shi, Kyoto (JP)

(21) Appl. No.: 13/517,090

(22) PCT Filed: Dec. 22, 2010
(86) PCT No.: PCT/JP2010/073158

§ 371 Date: Jun. 19, 2012

(30) Foreign Application Priority Data
Dec. 24, 2009 (JP) 2009-291867
Dec. 24, 2009 (JP) 2009-291868

(51) Int. Cl. G06F 3/044; B32B 37/12; B32B 37/14

(52) U.S. Cl. 345/174; 156/306.6

(57) ABSTRACT

Provided is a capacitive touch sensor, in which an adhesion layer can be prevented from being whitened by water vapor, while deterioration of optical characteristics is prevented. A transparent base material sheet (312), a transparent conductive-film layer (313), and a transparent adhesion layer (314) are formed on a protection sheet (311). The adhesion layer (314) is formed on the transparent conductive-film layer (313) so as to cover the transparent conductive-film layer (313). The protection sheet (313) has a water vapor transmission rate of 1 g/(m²·day·atm) or smaller, and an in-plane direction retardation value of 20 nm or smaller at a wavelength of 550 nm. The base material sheet (312) has an in-plane direction retardation value of 20 nm or smaller at a wavelength of 550 nm.

### TECHNICAL FIELD

The present invention relates to a capacitive touch sensor, an electronic device including a capacitance type sensor, and a method of manufacturing a transparent conductive-film laminate used for the capacitive touch sensor or the like.

### BACKGROUND ART

Conventionally, a transparent sheet-like body including a transparent conductive-film described in Patent Citation 1 (International Publication 2006/126604 Pamphlet) is used for a transparent touch screen or a transparent touch switch.

This transparent conductive-film is patterned, and a detection electrode is formed on the transparent conductive-film. The detection electrode of the transparent conductive-film and an external circuit are connected to each other using a flexible printed circuit (hereinafter referred to as an FPC) or the like. A change in capacitance between the detection electrode and a finger or a pen is transmitted to the external circuit, so that the position where the finger or the pen touches on the transparent sheet-like body can be detected by the external circuit. In other words, a capacitive touch sensor is formed by connecting the FPC to the patterned transparent conductive-film that is laminated on the transparent sheet.

The capacitive touch sensor usually has a following structure. The transparent conductive-film is laminated on a plastic film, and a transparent adhesion layer is formed to cover the transparent conductive-film. The transparent conductive-film is laminated between an insulating layer for protecting the transparent conductive-film and the plastic film.

Further, epoxy-based resin or acrylic-based resin is used in the transparent adhesion layer, and the adhesion layer has a thickness of approximately 25 to 75 μm. If the epoxy-based resin or acrylic adhesion layer having a thickness of 25 to 75 μm is exposed to an environment of high temperature and high humidity, it may absorb moisture in the outside air so that its surface may be whitened.

### DISCLOSURE OF INVENTION

### Technical Problem

Therefore, it has been considered to increase the thickness of the plastic film or to use a plastic film having high water vapor barrier performance so as to reduce the entering of the water vapor. However, if the thickness of the plastic film is increased or if the plastic film having high water vapor barrier performance is used, although the whitening can be prevented, there is a problem in which optical characteristics may be deteriorated.

It is an object of the present invention to provide a capacitive touch sensor that can prevent the adhesion layer from being whitened by water vapor while preventing deterioration of optical characteristics.

Patent Citation 1: International Publication 2006/126604 Pamphlet

### Technical Solution

A capacitive touch sensor according to an aspect of the present invention includes a transparent plastic sheet, a transparent conductive-film layer formed on the plastic sheet, and a transparent adhesion layer formed on the transparent conductive-film layer so as to cover the transparent conductive-film layer, in which the plastic sheet has water vapor transmission rate of 1 g/(m²·day·atm) or lower and an in-plane direction retardation value of 20 nm or smaller at a wavelength of 550 nm.

In the capacitive touch sensor, because the plastic sheet has water vapor transmission rate of 1 g/(m²·day·atm) or lower, it is possible to prevent water vapor from entering the adhesion layer and the transparent conductive-film layer laminated on the plastic sheet. In addition, because the plastic sheet has an in-plane direction retardation value of 20 nm or smaller, despite that the plastic sheet has the water vapor barrier performance, it is possible to prevent occurrence of color shading or optical problems in which a color viewed by a user becomes a color different from that of light emerging from a liquid crystal display apparatus.

The capacitive touch sensor may further include a phase difference film disposed on a side of the adhesion layer opposite to the plastic sheet, and a polarizing film disposed on the phase difference film.

In this capacitive touch sensor, depending on the type of the display apparatus, transparency for light from the light source of the display apparatus can be improved by appropriately arranging the polarizing film. Using the polarizing film and the phase difference film, it is possible to suppress reflection of light having passed through the polarizing film and the phase difference film, and to suppress reflection of light by the transparent conductive-film layer so that the pattern of the transparent conductive-film layer is hardly visible. By setting the in-plane direction retardation value of the plastic sheet to 20 nm or smaller, the performance of the polarizing film and the phase difference film can be sufficiently exerted without deterioration.

The plastic sheet may include a transparent plastic base material sheet having a surface on which the transparent conductive-film layer is formed, and an in-plane direction retardation value of 20 nm or smaller at a wavelength of 550 nm, and a transparent protection sheet that is disposed on the other surface of the base material sheet and has water vapor transmission rate of 1 g/(m²·day·atm) or lower and an in-plane direction retardation value of 20 nm or smaller at a wavelength of 550 nm. In this case, it is preferred that the protection sheet be made of cycloolefin-based resin. In addition, it is preferred that the base material sheet be made of polycarbonate-based resin. Further, the protection sheet may be formed in a three-dimensional shape so as to cover a side surface of the adhesion layer. The protection sheet formed in a three-dimensional shape can prevent entry of water vapor from the side surface into the adhesion layer.

The plastic sheet may be a transparent base material sheet having water vapor transmission rate of 1 g/(m²·day·atm) or lower and an in-plane direction retardation value of 20 nm or smaller at a wavelength of 550 nm. In this case, it is preferred that the base material sheet be formed of cycloolefin-based resin. The base material sheet may be formed in a three-dimensional shape so as to cover a side surface of the adhesion layer. The base material sheet formed in a three-dimensional shape can prevent entry of water vapor from the side surface into the adhesion layer, too.

The capacitive touch sensor may further include an optically isotropic sheet that is disposed on the adhesion layer and has an in-plane direction retardation value of 20 nm or smaller at a wavelength of 550 nm, another transparent conductive-film layer formed on the optically isotropic sheet, and another transparent adhesion layer formed on the another transparent conductive-film layer.

An electronic device may have a structure including a case, a display apparatus disposed in the case, and the above-mentioned capacitive touch sensor disposed on the display apparatus in the case.

A method of manufacturing a transparent conductive-film laminate according to another aspect of the present invention includes a step of disposing a transparent base material sheet having an in-plane direction retardation value of 20 nm or smaller at a wavelength of 550 nm on a transparent plastic protection sheet having water vapor transmission rate of 1 g/(m²·day·atm) or lower and an in-plane direction retardation value of 20 nm or smaller at a wavelength of 550 nm, a conductive-film layer forming step of forming a transparent conductive-film layer on the base material sheet, an adhesion layer forming step of forming a transparent adhesion layer on the transparent conductive-film layer so as to cover the transparent conductive-film layer, and a side surface covering step of covering a side surface of the adhesion layer with the protection sheet.

With this manufacturing method, it is possible to easily manufacture the transparent conductive-film laminate in which the side surface of the adhesion layer is covered with the protection sheet.

The method of manufacturing a transparent conductive-film laminate may further include a forming step of forming the protection sheet into a three-dimensional shape before the covering step.

A method of manufacturing a transparent conductive-film laminate according to another aspect of the present invention includes a conductive-film layer forming step of forming a transparent conductive-film layer on a transparent plastic base material sheet having water vapor transmission rate of 1 g/(m² ·day·atm) or lower and an in-plane direction retardation value of 20 nm or smaller at a wavelength of 550 nm, an adhesion layer forming step of forming a transparent adhesion layer on the transparent conductive-film layer so as to cover the transparent conductive-film layer, and a side surface covering step of covering a side surface of the adhesion layer with the base material sheet.

With this manufacturing method, it is possible to easily manufacture the transparent conductive-film laminate in which the side surface of the adhesion layer is covered with the base material sheet.

The method of manufacturing a transparent conductive-film laminate may further include a forming step of forming the base material sheet into a three-dimensional shape before the covering step.

### Advantageous Effects

According to the present invention, it is possible to prevent the adhesion layer from being whitened by water vapor while preventing the occurrence of color shading in the transmitted light

### BRIEF DESCRIPTION OF DRAWINGS

FIG. 1 is an exploded perspective view of a cellular phone equipped with a capacitive touch sensor according to a first embodiment.

FIG. 2 is a partial cross sectional view schematically illustrating a cross-sectional shape of the cellular phone of FIG. 1.

FIG. 3 is an enlarged view of a region I of FIG. 2.

FIG. 4 is a schematic cross sectional view illustrating a manufacturing step of the capacitive touch sensor illustrated in FIG. 2.

FIG. 5 is a schematic cross sectional view illustrating a manufacturing step of the capacitive touch sensor illustrated in FIG. 2.

FIG. 6 is a schematic cross sectional view illustrating a manufacturing step of the capacitive touch sensor illustrated in FIG. 2.

FIG. 7 is a schematic cross sectional view illustrating a structure of a capacitive touch sensor of Variation Example 1-1.

FIG. 8 is a schematic cross sectional view illustrating a structure of a capacitive touch sensor of Variation Example 1-2.

FIG. 9 is a schematic cross sectional view illustrating another structure of the capacitive touch sensor of Variation Example 1-2.

FIG. 10 is a schematic cross sectional view illustrating a structure of a capacitive touch sensor according to a second embodiment.

FIG. 11 is a schematic cross sectional view illustrating a manufacturing step of the capacitive touch sensor of FIG. 10.

FIG. 12 is a schematic cross sectional view illustrating another manufacturing step of the capacitive touch sensor of FIG. 10.

FIG. 13 is a schematic cross sectional view of a structure of a capacitive touch sensor of Variation Example 2-1.

FIG. 14 is an enlarged view of a region I of FIG. 13.

FIG. 15 is a schematic cross sectional view illustrating a structure of a capacitive touch sensor of Variation Example 2-2.

FIG. 16 is a schematic cross sectional view illustrating another structure of the capacitive touch sensor of Variation Example 2-2.

FIG. 17 is a schematic cross sectional view illustrating a structure of a capacitive touch sensor according to a third embodiment.

### EXPLANATION OF REFERENCE

10, 10A cellular phone

11 case

20 liquid crystal display apparatus

22 phase difference film

30, 30A, 30B, 30C, 40, 40A, 40B, 40C, 50 capacitive touch sensor

31, 31A, 31B, 31C, 41, 41A, 41B, 41C, 51 transparent conductive-film laminate

311 protection sheet

312, 411, 415 base material sheet

313, 412 transparent conductive-film layer

314, 413 adhesion layer

414 optically isotropic sheet

511 polarizing film

512 phase difference film

### BEST MODE FOR CARRYING OUT THE INVENTION

### First Embodiment

An electronic device equipped with a capacitive touch sensor according to a first embodiment of the present invention is described below with reference to an example of a cellular phone. However, the electronic device equipped with the capacitive touch sensor may be electronic devices other than the cellular phone, for example, a personal computer, a vending machine, or the like. The electronic device to which the present invention can be applied is not limited to the cellular phone.

(1) General Outline of the Electronic Device Equipped with the Capacitive Touch Sensor

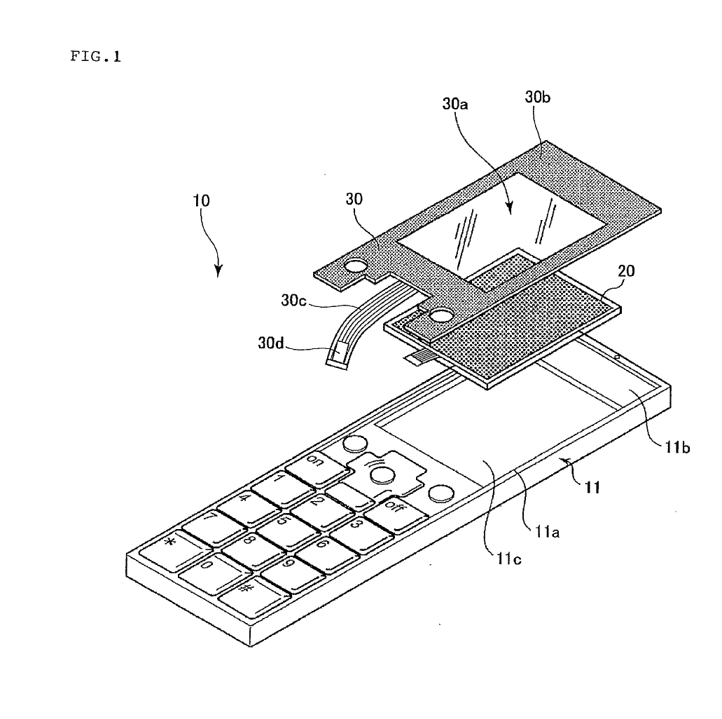

FIG. 1 is an exploded perspective view illustrating a general outline of a structure of the cellular phone. In FIG. 1, a cellular phone 10 includes a liquid crystal display apparatus 20, and a capacitive touch sensor 30 disposed on the liquid crystal display apparatus 20. A case 11 of the cellular phone 10 has a recess 11b on a front side 11a. The capacitive touch sensor 30 is fit into the recess 11b. Then, there is further formed a recess 11c in the recess 11b. The liquid crystal display apparatus 20 is fit into the recess 11c. In the electronic device such as the cellular phone 10, the capacitive touch sensor 30 is disposed on the liquid crystal display apparatus 20 in this way.

The capacitive touch sensor 30 includes a transparent touch sensor portion 30a, an opaque decorating portion 30b formed around the touch sensor portion 30b an FPC 30c, and an integrated circuit (IC) chip 30d mounted on the FPC 30c. The FPC 30c is connected to a circuit (not shown) inside the cellular phone 10. However, there may also be a type of capacitive touch sensor having the FPC without the IC chip.

A design pattern layer may be formed appropriately in the decorating portion 30b so as to improve the external design. The design pattern layer is formed using coloring ink containing pigment or dye of appropriate color as coloring agent with polyvinyl, polyamide, polyacrylic, polyurethane, or alkyd resin as binder. As the coloring agent used for this, there may be pearl pigment in which titanium oxide is coated on metal grains of aluminum, titanium, bronze, or the like, or mica. As a method of forming the design pattern layer, there may be general printing methods such as gravure, screen, and offset printing methods, and various coating methods, painting methods, and the like.

(2) Transparent Conductive-Film Laminate 31

(2-1) Outline of Structure

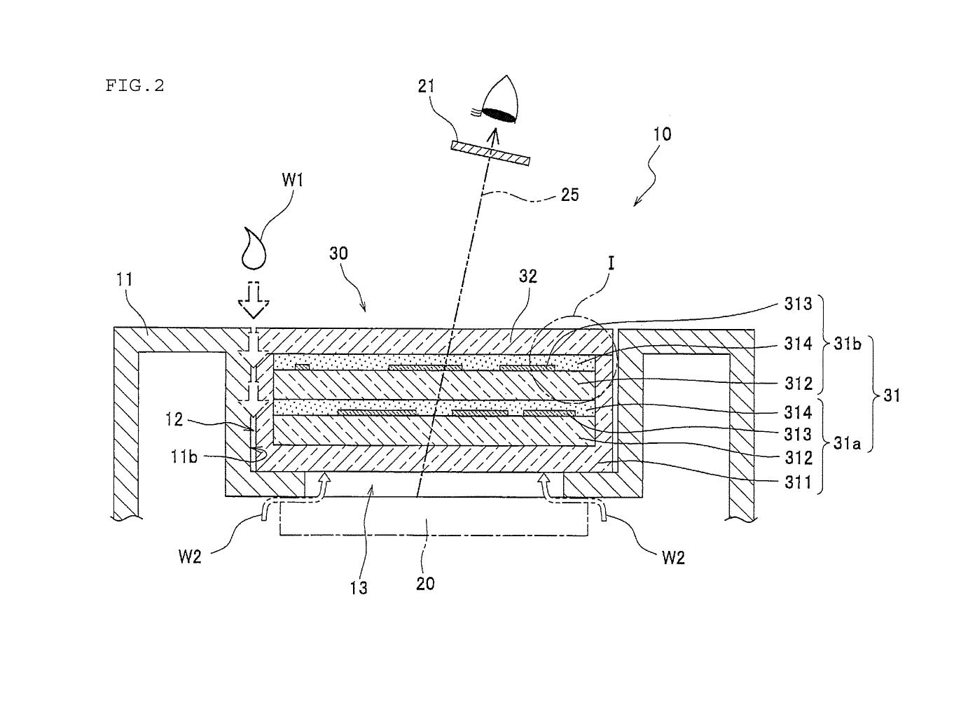

FIG. 2 is a schematic partial cross sectional view of the cellular phone 10 illustrated in FIG. 1. A part constituted of the touch sensor portion 30a and the decorating portion 30b includes a transparent conductive-film laminate 31 illustrated in FIG. 2 and other member 32. The other member 32 may be a glass substrate, for example.

The transparent conductive-film laminate 31 includes a protection sheet 311, a base material sheet 312, a transparent conductive-film layer 313, and an adhesion layer 314. The transparent conductive-film laminate 31 has a two-layer structure in which similar structures are repeated. As a first layer 31a, the first transparent conductive-film layer 313 is formed on one side (one surface) of the first base material sheet 312 of the first layer. The protection sheet 311 is laminated on the opposite side (opposite surface) of the first base material sheet 312. On the first base material sheet 312 and the first transparent conductive-film layer 313, there is laminated the first adhesion layer 314 covering the first transparent conductive-film layer 313.

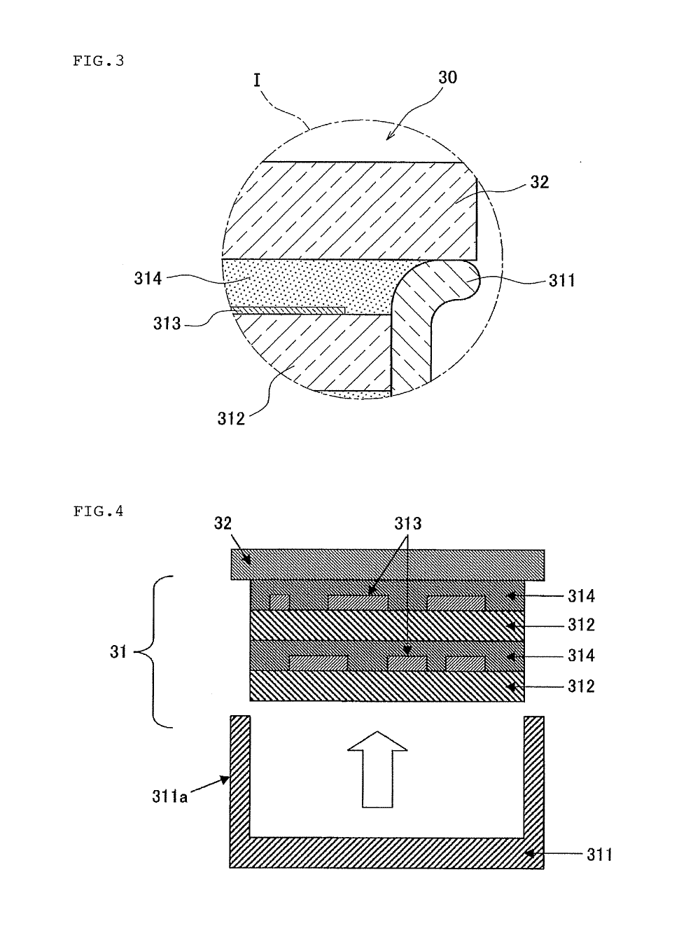

As a second layer 31b, there is the second base material sheet 312. The second base material sheet 312 is laminated on the first adhesion layer 314. The second transparent conductive-film layer 313 is formed on the second base material sheet 312, and the second adhesion layer 314 is laminated on the second base material sheet 312 and the second transparent conductive-film layer 313. On the second adhesion layer 314, there is laminated the other member 32. Then, the protection sheet 311 is formed in a three-dimensional shape and covers side surfaces of the adhesion layers 314 of the first layer 31a and the second layer 31b. FIG. 3 is an enlarged view of a region I enclosed by a dashed dotted line in FIG. 2. The protection sheet 311 is formed so as to be in close contact with the other member 32 as illustrated in FIG. 3. With this structure, the side surface of the adhesion layer 314 of the second layer 31b is covered without a gap, and hence it is possible to prevent water vapor from entering the adhesion layers 314 of the first layer 31a and the second layer 31b through a gap between the other member 32 and the protection sheet 311. Because the protection sheet 311 has high water vapor barrier performance, it is also possible to prevent water vapor from entering the adhesion layers 314 of the first layer 31a and the second layer 31b after passing through the protection sheet 311. For instance, as illustrated in FIG. 2, even if a waterdrop W enters the cellular phone 10 through a gap 12 between the case 11 and the transparent conductive-film laminate 31, it is possible to prevent entry of water vapor from the side surface of the transparent conductive-film laminate 31 as described above. Similarly, in regard to water vapor W2 entering a gap 13 from the inside of the cellular phone 10, the protection sheet 311 can prevent the same from entering the adhesion layer 314.

Note that in the transparent conductive-film laminate 31 illustrated in FIG. 2, the structure constituted of the base material sheet 312, the transparent conductive-film layer 313, and the adhesion layer 314 is repeated twice, but such a structure may also be repeated three or more times.

(2-2) Base Material Sheet 312

The base material sheet 312 is a transparent sheet having an in-plane direction retardation value of 20 nm or smaller at a wavelength of 550 nm. It is preferred that a thickness of the base material sheet 312 be approximately 30 to 2000 μm. As a material of the base material sheet 312 having an in-plane direction retardation value of 20 nm or smaller, there exists a plastic film made of polycarbonate-based resin, polyarylate-based resin, cellulose-based resin, norbornene-based resin, polystyrene-based resin, olefin-based resin, acrylic-based resin, or the like. Among them, a plastic film made of polycarbonate-based resin is particularly preferred because it allows an in-plane direction retardation value of 5 nm or smaller when the film forming conditions are appropriately adjusted. Note that the concept of polycarbonate-based resin mentioned here includes polycarbonate resin.

The in-plane retardation value in the present invention is measured using a low retardation measurement apparatus (Model RE-100) manufactured by Otsuka Electronics Co., Ltd. A measurement wavelength of this low retardation measurement apparatus is 550 nm. Note that the retardation is a phenomenon in which the light entering a crystal or other anisotropic substance splits into two light waves having oscillation directions perpendicular to each other. When unpolarized light enters a material having birefringence, the incident light splits into two. They have oscillation directions perpendicular to each other, one of which is referred to as vertically polarized light, and the other is referred to as horizontally polarized light. The vertically polarized light becomes an abnormal light beam, and the horizontally polarized light becomes a normal light beam. The normal light beam is a light beam having a propagation speed independent of propagation direction, and the abnormal light beam is a light beam having different speeds depending on the propagation direction. The birefringence material has a direction in which the two light beams have the same speed, and this direction is referred to as an optical axis. The in-plane direction retardation value is a value calculated by (nx−ny)×d, where nx denotes refractive index in a slow axis direction in the in-plane direction of the sheet 312, ny denotes a refractive index in a fast axis direction in the in-plane direction of the sheet, and d denotes a thickness of the sheet.

Note that many plastic films including polycarbonate-based resin and having a low in-plane direction retardation value have high water vapor transmission rate so as to easily allow water vapor to transmit. The water vapor transmission rate mentioned here means a value measured according to JISK7129B method under conditions including temperature of a permeation cell at 40±0.5 degrees centigrade, relative humidity difference of 90±2%, relative humidity of a high humidity chamber at 90±2%, and relative humidity of a low humidity chamber at 0%. High water vapor transmission rate means that water vapor transmission rate of the entire sheet is 10 g/(m²·24 h) or higher when it is measured under the above-mentioned conditions according to the JISK7129B method.

(2-3) Protection Sheet 311

The protection sheet 311 is a transparent plastic sheet having a water vapor transmission rate of 1 g/(m²·24 h) or lower and an in-plane direction retardation value of 20 nm or smaller at a wavelength of 550 nm when measured under the above-mentioned conditions according to the JISK712B method. It is preferred that a thickness of this protection sheet 311 be appropriately 30 to 2000 μm. As material of the protection sheet 311, there exists a plastic film made of cycloolefin-based resin. The cycloolefin-based resin film has high water vapor barrier performance and low in-plane direction retardation value, and is also easy to process into a three-dimensional shape. As cycloolefin-based resin having a water vapor transmission rate of 1 g/(m²·24 h) or lower and an in-plane direction retardation value of 5 nm or smaller at a wavelength of 550 nm, for example, ZEONOR (registered trademark) manufactured by ZEON CORPORATION may be used appropriately.

(2-4) Transparent Conductive-Film Layer 313

As the transparent conductive-film layer 313, there exists a layer made of metal oxide such as indium tin oxide or zinc oxide, or made of resin binder and carbon nanotube or metal nanowire, which can be formed by a vacuum deposition method, a sputtering method, an ion plating method, a plating method, a general printing method such as gravure, screen, or offset printing, a method using various coaters, a painting method, a dipping method, or the like. It is preferred to set the thickness of the transparent conductive-film layer 313 to approximately a few tens nm to a few μm, to set the light beam transmittance to 80% or higher, and to set a surface resistance to a value of a few mΩ to a few hundreds Ω.

(2-5) Adhesion Layer 314

The adhesion layer 314 may be a layer made of acrylic-based resin, polyurethane-based resin, vinyl-based resin, rubber-based resin, or the like, and is formed by a general printing method such as gravure, screen, or offset printing, a method using various coaters, a painting method, a dipping method, or the like. It is preferred that the adhesion layer 314 is formed to have a thickness of approximately a few μm to a few tens μm, and shows strong adhesiveness and various resistances.

(3) Method of Manufacturing Transparent Conductive-Film Laminate

(3-1) Method of Using Protection Sheet Having Three-Dimensional Shape

As a method of manufacturing the protection sheet 311 so as to result in a structure covering the side surface of the adhesion layer 314, there exists a method of laminating the protection sheet 311 having formed into a three-dimensional shape on the base material sheet 312 through the step illustrated in FIG. 4. As illustrated in FIG. 4, the protection sheet 311 is formed in advance so that a peripheral processed part 311a of the protection sheet 311 reaches side surfaces of the adhesion layer 314 and the like. As a method of forming the protection sheet 311 in advance in a three-dimensional shape to cover the side surfaces of the adhesion layer 314 and the like, there exist press forming, vacuum forming, air pressure forming, and the like. The press forming is performed at a temperature higher than the softening temperature of the protection sheet 311. For instance, if the protection sheet 311 is made of cycloolefin-based resin having a softening temperature of 120 degrees centigrade, the protection sheet 311 is formed by heating to 160 degrees centigrade. As a method of laminating the protection sheet 311 in a three-dimensional shape on the base material sheet 312, there exists a method of laminating via adhesive or the like.

(3-2) Method of Forming Protection Sheet in Three-Dimensional Shape

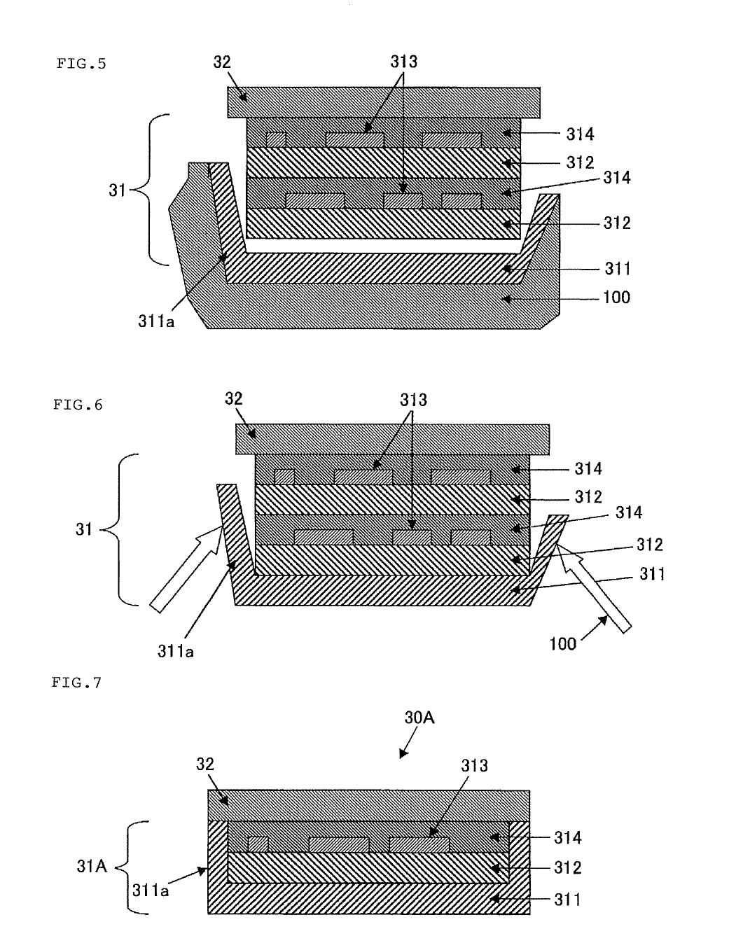

As a method of manufacturing the protection sheet 311 so as to result in a structure covering the side surface of the adhesion layer 314, there exists a method of laminating the protection sheet 311 while forming it into a three-dimensional shape along the side surfaces of the adhesion layer 314 and the like so as to cover the side surfaces of the adhesion layer 314 and the like, through the step illustrated in FIG. 5.

As a method of laminating the protection sheet 311 on the base material sheet 312 while processing it into a three-dimensional shape so as to be along the side surfaces of the adhesion layer 314 and the like, there exists a method of pressing by a rubber-like pressing member 100 such as a silicone pad. In the method of pressing by the pressing member 100, the protection sheet 311 is first heated to a temperature higher than the softening temperature so that the protection sheet 311 is in a softened state. Next, the protection sheet 311 is pressed by the rubber-like pressing member 100 so as to be formed along the side surface of the adhesion layer 314, while the protection sheet 311 is laminated on the side surface of the adhesion layer 314. For instance, if the protection sheet 311 is made of cycloolefin-based resin having a softening temperature of 120 degrees centigrade, the transparent conductive-film laminate 31 may be formed by pressing the protection sheet 311 using a silicone pad heated to 150 degrees centigrade. In order to laminate the protection sheet 311 on the side surface, it is possible to apply adhesive onto the protection sheet 311 in advance in the same manner as the above-mentioned method or to use adhesive of the adhesion layer 314.

(3-3) Method of Forming Three-Dimensional Shape After Laminating Protection Sheet

As a method of manufacturing the protection sheet 311 so as to result in a structure covering the side surface of the adhesion layer 314, there exists a method of processing the protection sheet 311 to be along the side surfaces of the adhesion layer 314 and the like after laminating the protection sheet 311 on the base material sheet 312, through the step of illustrated in FIG. 6.

As a method of processing the protection sheet 311 to be along the side surfaces of the adhesion layer 314 and the like after laminating the protection sheet 311 on the base material sheet 312, there exists a forming technique in which compressed air 110 or the like at high temperature and high pressure may be blown to the glued protection sheet 311. The protection sheet 311 is heated to the softening temperature or higher, and the compressed air at a temperature higher than the softening temperature is blown. For instance, if the protection sheet 311 is made of cycloolefin-based resin having a softening temperature of 120 degrees centigrade, the peripheral processed part 311a of the protection sheet 311 is made to be in close contact with the side surface of the adhesion layer 314 by force of compressed air at a temperature of 150 degrees centigrade and 10 atmospheric pressure. It is possible to cover the transparent conductive-film laminate 31 with heat resistance sheet or the like so as to transmit the force of the compressed air to the protection sheet 311 indirectly via the heat resistance sheet. In addition, it is possible to adopt air pressure forming in which the compressed air is blown from the side of the other member 32 so as to press the protection sheet 311 to a mold heated to the softening temperature of the protection sheet 311 or higher.

### Variation Example 1-1

In the embodiment described above, there is shown a case where the base material sheets 312, the transparent conductive-film layers 313, and the adhesion layers 314, of two layers each, are laminated in the transparent conductive-film laminate 31. However, as illustrated in FIG. 7, it is also possible to laminate these layers by one layer each. Although not illustrated in FIG. 7, a capacitive touch sensor 30A is constituted by connecting the FPC 30c illustrated in FIG. 1 to the transparent conductive-film layer 313 of a transparent conductive-film laminate 31A. This capacitive touch sensor 30A can also be combined with the liquid crystal display apparatus 20 illustrated in FIG. 1 and be mounted in the electronic device such as the cellular phone 10.

### Variation Example 1-2

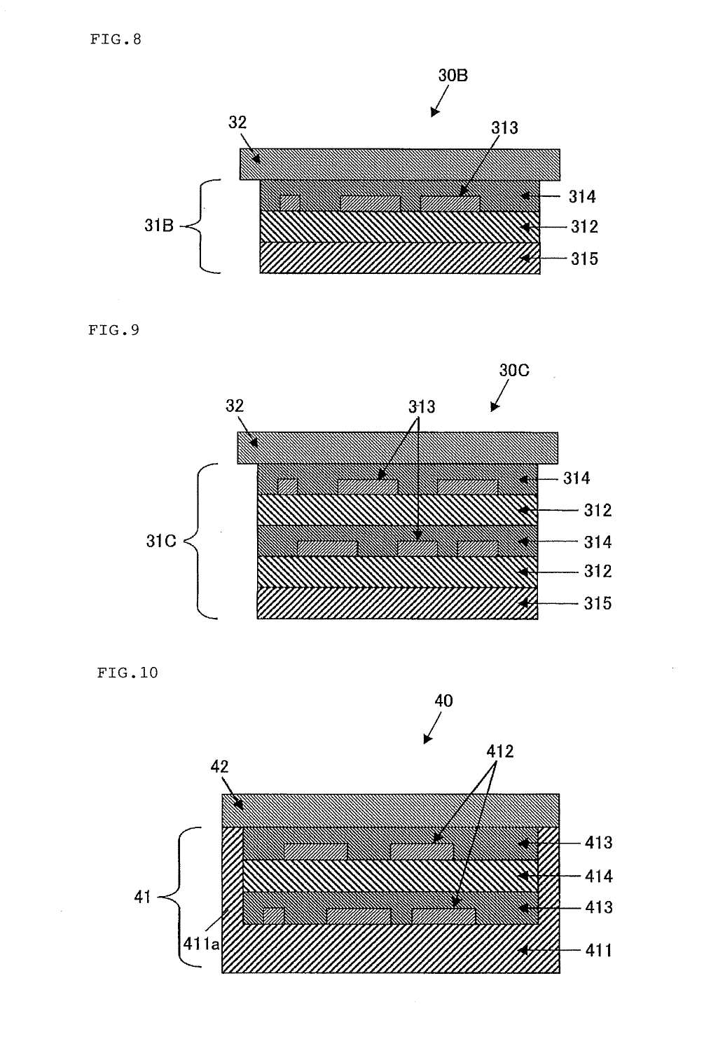

In the transparent conductive-film laminate 31 of the above-mentioned embodiment and the transparent conductive-film laminate 31A described in Variation Example 1-1, the side surface of the adhesion layer 314 is covered with the peripheral processed part 311a of the protection sheet 311. However, if the cellular phone 10 has high waterproofness on the front side 11a, it may not be necessary to cover the side surface of the adhesion layer 314 with the protection sheet 311. In this case, it is sufficient to laminate a protection sheet 315 only on the other side of the base material sheet 312, as shown in a transparent conductive-film laminate 31B of FIG. 8 or a transparent conductive-film laminate 31C of FIG. 9. In this case, the structure and the manufacturing method may be simplified. Although not illustrated in FIGS. 8 and 9, a capacitive touch sensor 30B or 30C is constituted by connecting the FPC 30c illustrated in FIG. 1 to the transparent conductive-film layer 313 of the transparent conductive-film laminate 31B or 31C. This capacitive touch sensor 30B or 30C can also be combined with the liquid crystal display apparatus 20 illustrated in FIG. 1 and be mounted in the electronic device such as the cellular phone 10.

### Example 1

(1) Manufacture of Transparent Conductive-Film Laminate

A polycarbonate-based resin film having a thickness of 50 μm was used as the base material sheet, and on a surface thereof a transparent conductive-film layer made of indium tin oxide having a thickness of 200 nm was formed by a sputtering method. The polycarbonate-based resin film that was used had an in-plane direction retardation value of 20 nm or smaller and water vapor transmission rate of 10 g/(m²·24 h) or higher. Further, a polyurethane adhesion layer having a thickness of 25 μm was printed by screen printing on the polycarbonate-based resin film on which the transparent conductive-film layer was formed. Ten sets of transparent conductive-film laminates were manufactured and prepared in this way.

Next, as for five sets of the above-mentioned transparent conductive-film laminates, the protection sheet constituted of cycloolefin-based resin film having a thickness of 100 μm and a softening temperature of 120 degrees centigrade was laminated on the surface of the base material sheet opposite to the surface on which the adhesion layer was formed, and the protection sheet was pressed by the silicone pad heated to 150 degrees centigrade from the backside. The cycloolefin-based resin film that was used had an in-plane direction retardation value of 5 nm or smaller and water vapor transmission rate of 1 g/(m²·24 h). The region pressed by the silicone pad was set to be larger than the size of the base material sheet, and the softened protection sheet was laminated by such pressure to the side surface of the adhesion layer along the side surfaces of the base material sheet and the adhesion layer. As for the remaining five sets, the protection sheet was not laminated. Note that a glass substrate was laminated as the other member on the ten sets of transparent conductive-film laminates.

(2) Resistance Evaluation of Transparent Conductive-Film Laminate

The five sets with the laminated protection sheet and the five sets without the laminated protection sheet were put into a humidity proof test machine at 60 degrees centigrade and at a relative humidity of 90% for ten days. Then, the surface conditions were inspected by eye. All the five sets with the laminated protection sheet had no abnormal findings. However, as for the five sets without the laminated protection sheet, all of them had a whitened adhesion layer, and one set among them had also a slightly whitened transparent conductive-film layer.

### Example 2

(1) Manufacture of Transparent Conductive-Film Laminate

A polycarbonate-based resin film having a thickness of 50 μm was used as the base material sheet, and on a surface thereof a transparent conductive-film layer made of indium tin oxide having a thickness of 200 nm was formed by a sputtering method. The polycarbonate-based resin film that was used had an in-plane direction retardation value of 20 nm or smaller and water vapor transmission rate of 10 g/(m²·24 h) or higher. Further, a polyurethane adhesion layer having a thickness of 25 μm was printed by screen printing on the polycarbonate-based resin film on which the transparent conductive-film layer was formed. A similar polycarbonate-based resin film was laminated on the adhesion layer, and further a polyurethane adhesion layer having a thickness of 25 μm was formed on the polycarbonate-based resin film by the above-mentioned method. This method was repeated so as to laminate a total of three layers each including the base material sheet, the transparent conductive-film layer, and the adhesion layer. Ten sets of transparent conductive-film laminates were manufactured and prepared in this way.

Then, a cycloolefin-based resin film having a thickness of 100 μm and a softening temperature of 120 degrees centigrade was heated to 160 degrees centigrade, so as to form a rising part of approximately 200 μm on the periphery of the cycloolefin-based resin film by press forming. Thus, the protection sheet having a three-dimensional shape was prepared. The cycloolefin-based resin film that was used had an in-plane direction retardation value of 5 nm or smaller and water vapor transmission rate of 1 g/(m²·24 h). Next, as for five sets of the above-mentioned transparent conductive-film laminates, epoxy-based adhesive was applied to the inner surface of the protection sheet having three-dimensional shape, and the protection sheet was glued to the surface of the lowest laminated base material sheet opposite to the surface on which the adhesion layer was formed. A flat inner surface region of the protection sheet corresponded to outer dimensions of the base material sheet. The lowest base material sheet was covered with the protection sheet by lamination, and the side surface of the upper base material sheet and the side surface of the adhesion layer were also covered. The protection sheet was not laminated for the remaining five sets. Note that a glass substrate was laminated as the other member on the ten sets of transparent conductive-film laminates.

(2) Resistance Evaluation of Transparent Conductive-Film Laminate

The five sets with the adhered protection sheet and the five sets without the adhered protection sheet were put into a humidity proof test machine at 60 degrees centigrade and at a relative humidity of 90% for ten days. Then, the surface conditions were inspected by eye. All the five sets with the adhered protection sheet had no abnormal findings. However, as for the five sets without the adhered protection sheet, all of them had a whitened adhesion layer, and three sets among them had also a substantially whitened transparent conductive-film layer.

### Example 3

(1) Manufacture of Transparent Conductive-Film Laminate

A polycarbonate-based resin film having a thickness of 50 μm was used as the base material sheet, and on a surface thereof a transparent conductive-film layer made of indium tin oxide having a thickness of 200 nm was formed by a sputtering method. The polycarbonate-based resin film that was used had an in-plane direction retardation value of 20 nm or smaller and water vapor transmission rate of 10 g/(m²·24 h) or higher. Further, a polyurethane adhesion layer having a thickness of 25 μm was printed by screen printing on the polycarbonate-based resin film on which the transparent conductive-film layer was formed. A similar polycarbonate-based resin film was laminated on the adhesion layer, and further a polyurethane adhesion layer having a thickness of 25 μm was formed on the polycarbonate-based resin film by the above-mentioned method. In this way, a total of two layers, each of which is constituted of the base material sheet, the transparent conductive-film layer, and the adhesion layer, are laminated. Ten sets of the transparent conductive-film laminates were prepared.

Next, as for five sets of the above-mentioned transparent conductive-film laminates, the protection sheet constituted of a cycloolefin-based resin film having a softening temperature of 120 degrees centigrade was glued via epoxy-based adhesive to the surface of the lowest laminated base material sheet opposite to the surface on which the adhesion layer was formed. The cycloolefin-based resin film that was used had an in-plane direction retardation value of 5 nm or smaller and water vapor transmission rate of 1 g/(m²·24 h). The protection sheet was set to be larger than the outer dimensions of the base material sheet. The peripheral part of the protection sheet was not adhered in the above-mentioned adhesion step, but after that the peripheral part of the protection sheet was adhered along the side surfaces of the upper base material sheet and the adhesion layer by the air pressure forming at 10 atmospheric pressure and at a temperature of 150 degrees centigrade. As for the remaining five sets, the protection sheet was not laminated. Note that a glass substrate was laminated as the other member on the ten sets of transparent conductive-film laminates.

(2) Resistance Evaluation of Transparent Conductive-Film Laminate

The five sets with the adhered protection sheet and the five sets without the adhered protection sheet were put into a humidity proof test machine at 60 degrees centigrade and at a relative humidity of 90% for ten days. Then, the surface conditions were inspected by eye. All the five sets with the adhered protection sheet had no abnormal findings. However, as for the five sets without the adhered protection sheet, all of them had a whitened adhesion layer, and one set of them had also a substantially whitened transparent conductive-film layer.

<Features>

(1)

Many plastic films having a low in-plane direction retardation value such as polycarbonate-based resin used for the base material sheet 312 have high water vapor transmission rate so as to easily allow water vapor to transmit. Therefore, there is a problem in which the adhesion layer 314 (and also the transparent conductive-film layer 313, depending on conditions) is whitened by water vapor passing through the base material sheet 312 if only the base material sheet 312 made of polycarbonate-based resin or the like is provided.

However, in the capacitive touch sensors 30, 30A, 30B, and 30C of the first embodiment, the water vapor transmission rate of the protection sheet 311 (plastic sheet) is 1 g/(m²·day·atm) or lower. Therefore, it is possible to prevent water vapor from entering the adhesion layer 314 and the transparent conductive-film layer 313 laminated on the base material sheet 312.

In particular, the adhesion layer excellent in adhesiveness and various resistances usually has a conspicuous problem of absorbing moisture and being whitened. Therefore, if an adhesive excellent in adhesiveness and various resistances is used, high effect can be exerted.

Both the base material sheet 312 made of polycarbonate-based resin and the protection sheet 311 (plastic sheet) made of cyclopolyolefin resin have an in-plane direction retardation value of 20 nm or smaller. Therefore, it is possible to prevent optical problems such as occurrence of color shading when emerging light 25 from the liquid crystal display apparatus 20 is viewed via a polarizing plate 21 such as sunglasses, as illustrated in FIG. 2, and optical problems in which a color viewed by the user becomes a color different from that of the light emerging from the liquid crystal display apparatus 20.

(2)

In the capacitive touch sensors 30 and 30A in which the peripheral processed part 311 a of the protection sheet 311 covers side surfaces of the first and second adhesion layers 314, it is possible to prevent entry of water vapor from the side surface into the adhesion layer 314, so that the effect of preventing the adhesion layer 314 from being whitened can be improved.

### Second Embodiment

The capacitive touch sensor according to a second embodiment of the present invention is described with reference to FIGS. 10 to 12. FIGS. 10 to 12 illustrate a transparent conductive-film laminate 41 and other member 42 in a structure of a capacitive touch sensor 40. The FPC 30c illustrated in FIG. 1 is connected to a transparent conductive-film layer 412 of the transparent conductive-film laminate 41 described later so that the capacitive touch sensor 40 of the second embodiment is constituted. Similarly to the capacitive touch sensor 30 of the first embodiment, the capacitive touch sensor 40 of the second embodiment can also be combined with the liquid crystal display apparatus 20 illustrated in FIG. 1 and be mounted in the electronic device such as the cellular phone 10.

(1) Transparent Conductive-Film Laminate 41

(1-1) Outline of Structure

FIG. 10 is a schematic cross sectional view illustrating the structure of the capacitive touch sensor 40. The capacitive touch sensor 40 includes the transparent conductive-film laminate 41 and the other member 42 illustrated in FIG. 10, and the FPC (not shown). The other member 42 may be a glass substrate or the like, for example.

The transparent conductive-film laminate 41 includes a base material sheet 411, the transparent conductive-film layers 412, adhesion layers 413, and an optically isotropic sheet 414. The first transparent conductive-film layer 412 is formed on a surface (one side) of the base material sheet 411. On the base material sheet 411 and the first transparent conductive-film layer 412, there is formed the first adhesion layer 413 to cover the first transparent conductive-film layer 412.

The optically isotropic sheet 414 is laminated on the first adhesion layer 413, and the second transparent conductive-film layer 412 is formed on the optically isotropic sheet 414. On the optically isotropic sheet 414 and the second transparent conductive-film layer 412, there is formed the second adhesion layer 413. Then, the other member 42 is laminated on the second adhesion layer 413. The base material sheet 411 is formed in a three-dimensional shape so as to cover the side surfaces of the first and second adhesion layers 413.

The base material sheet 411 is formed so as to be in contact with the other member 42. With this structure, the side surfaces of the first and second adhesion layers 413 are covered, and hence it is possible to prevent water vapor from entering the first and second adhesion layers 413 through a gap between the other member 42 and the base material sheet 411. Because this base material sheet 411 has high water vapor barrier performance, it is also possible to prevent water vapor from passing through the base material sheet 411 and entering the adhesion layer 413. For instance, if the capacitive touch sensor 30 used for the cellular phone 10 illustrated in FIG. 2 is replaced with the capacitive touch sensor 40, even if waterdrop W1 enters the cellular phone 10 through the gap 12 between the case 11 and the transparent conductive-film laminate 41, it is possible to prevent entry of water vapor from the side surface of the transparent conductive-film laminate 41 as described above. Similarly, in regard to the water vapor W2 from the inside of the cellular phone 10, the base material sheet 411 can prevent the water vapor from entering the adhesion layer 413.

Note that in the transparent conductive-film laminate 41 illustrated in FIG. 10, the structure constituted of the transparent conductive-film layer 412 and the adhesion layer 413 is repeated twice. However, it is also possible to adopt a structure in which the transparent conductive-film layer 412 is repeated three or more times, namely, for example, an optically isotropic sheet 414, a transparent conductive-film layer 412, and an adhesion layer 413 are further formed on the second adhesion layer 413.

(1-2) Base Material Sheet 411

The base material sheet 411 is a transparent plastic sheet having water vapor transmission rate of 1 g/(m²·24 h) or lower and an in-plane direction retardation value of 20 nm or smaller at a wavelength of 550 nm when measured under the above-mentioned conditions according to the JISK712B method. It is preferred that the thickness of the base material sheet 411 is approximately 30 to 2000 μm. As material of the base material sheet 411, there exists a plastic film made of cycloolefin-based resin. The cycloolefin-based resin film has high water vapor barrier performance and low in-plane direction retardation value, and is also easy to process into a three-dimensional shape. As cycloolefin-based resin having a water vapor transmission rate of 1 g/(m²·24 h) or lower and an in-plane direction retardation value of 5 nm or smaller at a wavelength of 550 nm, for example, ZEONOR (registered trademark) manufactured by ZEON CORPORATION may be used appropriately.

(1-3) Transparent Conductive-Film Layer 412 and Adhesion Layer 413

The transparent conductive-film layer 412 and the adhesion layer 413 can be formed in the same manner as the transparent conductive-film layer 313 and the adhesion layer 314 of the first embodiment, and therefore description thereof is omitted.

(1-4) Optically Isotropic Sheet 414

The optically isotropic sheet 414 is constituted of a transparent plastic film having an in-plane direction retardation value of 20 nm or smaller at a wavelength of 550 nm. It is preferred that the thickness of the optically isotropic sheet 414 be approximately 30 to 2000 μm. As material of the optically isotropic sheet 414 having an in-plane direction retardation value of 20 nm or smaller, there exists a plastic film made of polycarbonate-based resin, polyarylate resin, cellulose resin, norbornene resin, polystyrene resin, olefin resin, acrylic-based resin, or the like. Among them, the plastic film made of polycarbonate-based resin is particularly preferred because the in-plane direction retardation value can be 5 nm or smaller by appropriately setting the film forming condition.

(2) Method of Manufacturing Transparent Conductive-Film Laminate

(2-1) Method of Using Base Material Sheet Having Three-Dimensional Shape

As a method of forming the base material sheet 411 so as to result in a structure of covering the side surface of the adhesion layer 414 there exists a method in which the base material sheet 411 having formed in advance into a three-dimensional shape is used for covering the side surface of the adhesion layer 413 and the like. In this method, the first transparent conductive-film layer 412 and the first adhesion layer 413 are first formed on the base material sheet 411. After that, the base material sheet 411 on which the first transparent conductive-film layer 412 and the first adhesion layer 413 have been formed is formed into a three-dimensional shape. After that, the optically isotropic sheet 414 is formed on the bottom surface of the base material sheet 411, and the second transparent conductive-film layer 412 and the second adhesion layer 413 are formed on the optically isotropic sheet 414.

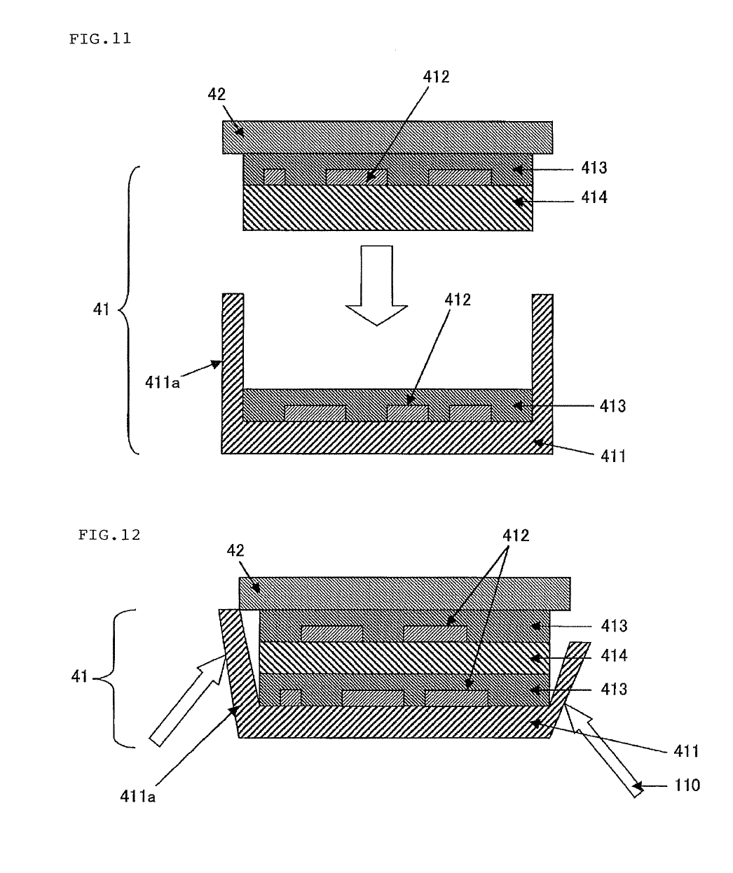

In addition, it is also possible to form the transparent conductive-film laminate 41 through the step illustrated in FIG. 11. FIG. 11 illustrates a method in which the first transparent conductive-film layer 412 and the first adhesion layer 413 are formed on the base material sheet 411, which is formed in a three-dimensional shape, and the optically isotropic sheet 414 on which the second transparent conductive-film layer 412, the second adhesion layer 413, and the other member 42 are laminated is combined and laminated onto the base material sheet 411.

As a method of forming the base material sheet 411 in advance in a three-dimensional shape so as to cover the side surfaces of the adhesion layer 413 and the like, there exists press forming, vacuum forming, air pressure forming, or the like. The press forming is performed at a temperature higher than the softening temperature of the base material sheet 411. For instance, if the base material sheet 411 is made of cycloolefin-based resin having a softening temperature of 120 degrees centigrade, the base material sheet 411 is formed by heating to 160 degrees centigrade. As a method of laminating the optically isotropic sheet 414 to the base material sheet 411 formed in a three-dimensional shape, there exists a method of laminating via adhesive or the like.

(2-2) Method of Forming in Three-Dimensional Shape After Lamination on Base Material Sheet

As a method of forming the base material sheet 411 so as to result in a structure of covering the side surface of the adhesion layer 314, there exists a method of processing the base material sheet 411 to be along the side surfaces of the adhesion layer 414 and the like after finishing the lamination on the base material sheet 411, through the step illustrated in FIG. 12. In this method, the first transparent conductive-film layer 412 and the first adhesion layer 413 are first formed on the base material sheet 411. Next, the optically isotropic sheet 414 is formed on the first adhesion layer 413, and further the second transparent conductive-film layer 412 and the second adhesion layer 413 are formed on the optically isotropic sheet 414. After that, the base material sheet 411 is processed to cover the side surface of the second adhesion layer 413 on the optically isotropic sheet 414.

As a method of processing the base material sheet 411 to be along the side surfaces of the adhesion layer 314 and the like, there exists a forming technique in which compressed air 110 or the like at high temperature and high pressure may be blown to the glued base material sheet 411. The base material sheet 411 is heated to the softening temperature or higher, and the compressed air at a temperature higher than the softening temperature is blown. For instance, if the base material sheet 411 is made of cycloolefin-based resin having a softening temperature of 120 degrees centigrade, the peripheral processed part 311a of the base material sheet 411 is made to be in close contact with the side surface of the adhesion layer 413 by force of compressed air at a temperature of 150 degrees centigrade and 10 atmospheric pressure. It is possible to cover the side of the transparent conductive-film laminate 31 with heat resistance sheet or the like so as to transmit the force of the compressed air to the base material sheet 411 indirectly via the heat resistance sheet or the like. In addition, it is possible to adopt air pressure forming in which the compressed air is blown from the side of the other member 32 so as to press the side of the base material sheet 411 to a mold heated to the softening temperature of the base material sheet 411 or higher.

### Variation Example 2-1

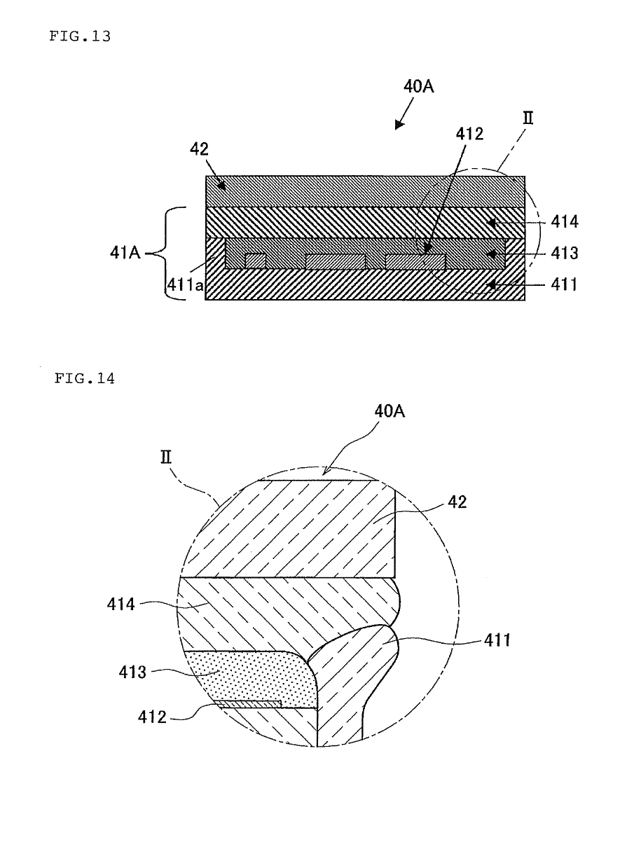

In the transparent conductive-film laminate 41 of the embodiment described above, there is shown a case where the transparent conductive-film layer 412 and the adhesion layer 413, of two layers each, are laminated. However, as illustrated in FIG. 13, it is also possible to laminate these layers by one layer each. FIG. 14 illustrates an enlarged view of a region II surrounded by the dashed dotted line in FIG. 13. As illustrated in FIG. 14, in the transparent conductive-film laminate 41, the base material sheet 411 is in close contact not with the other member 42 but with the optically isotropic sheet 414. Thus, a gap between the base material sheet 411 and the optically isotropic sheet 414 is eliminated so that water vapor cannot enter. Although not illustrated in FIG. 13, the FPC 30c illustrated in FIG. 1 is connected to the transparent conductive-film layer 412 of a transparent conductive-film laminate 41A, and hence a capacitive touch sensor 40A is constituted. This capacitive touch sensor 40A can also be combined with the liquid crystal display apparatus 20 illustrated in FIG. 1 and be mounted in the electronic device such as the cellular phone 10.

### Variation Example 2-2

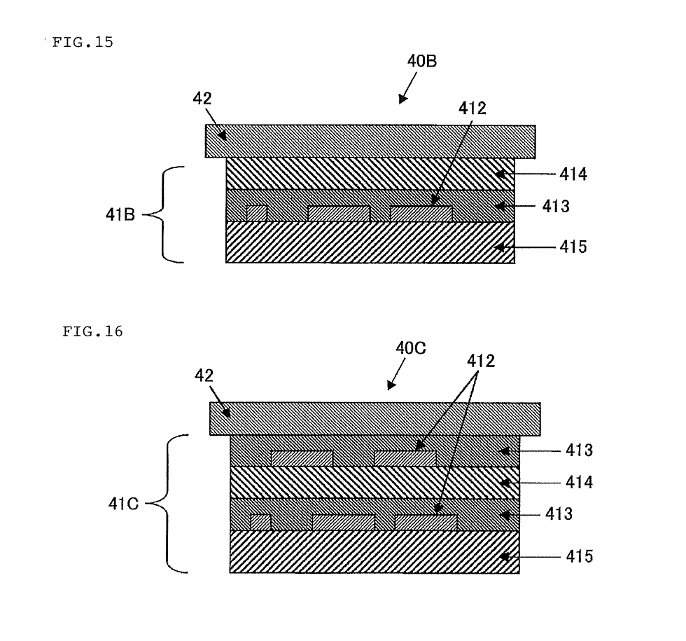

In the transparent conductive-film laminate 41 of the above-mentioned embodiment and the transparent conductive-film laminate 41A of Variation Example 2-1, the side surface of the adhesion layer 413 is covered with a peripheral processed part 411a of the base material sheet 411. However, if the cellular phone 10 has high water proofing property on the front side 11a, it may not be necessary to cover the side surface of the adhesion layer 413 with the base material sheet 411. In such case, it is possible to adopt a structure in which the side surface of the adhesion layer 413 is not covered with a base material sheet 415, as shown in a transparent conductive-film laminate 41B of FIG. 15 or a transparent conductive-film laminate 41C of FIG. 16. Thus, the structure and the manufacturing method may be simplified. Although not illustrated in FIGS. 15 and 16, the FPC 30c illustrated in FIG. 1 is connected to the transparent conductive-film layer 412 of the transparent conductive-film laminate 41B or 41C so that a capacitive touch sensor 40B or 40C is constituted. This capacitive touch sensor 40B or 40C can also be combined with the liquid crystal display apparatus 20 illustrated in FIG. 1 and be mounted in the electronic device such as the cellular phone 10.

### Example 4

(1) Manufacture of Transparent Conductive-Film Laminate

A cycloolefin-based resin film having a thickness of 50 μm was used as the base material sheet, and on a surface thereof a transparent conductive-film layer made of indium tin oxide having a thickness of 200 nm was formed by a sputtering method. The cycloolefin-based resin film that was used had an in-plane direction retardation value of 5 nm or smaller and water vapor transmission rate of 1 g/(m²·24 h). Further, a polyurethane adhesion layer having a thickness of 25 μm was formed by screen printing on the cycloolefin-based resin film on which the transparent conductive-film layer was formed. Five sets of transparent conductive-film laminates were manufactured and prepared in this way.

In addition, for comparison, a polycarbonate-based resin film having a thickness of 50 μm was used as the base material sheet, and on a surface thereof a transparent conductive-film layer made of indium tin oxide having a thickness of 200 nm was formed by a sputtering method. The polycarbonate-based resin film that was used had an in-plane direction retardation value of 20 nm or smaller and water vapor transmission rate of 10 g/(m²·24 h) or higher. Further, a polyurethane adhesion layer having a thickness of 25 μm was printed by screen printing on the polycarbonate-based resin film on which the transparent conductive-film layer was formed. Five sets of transparent conductive-film laminates were manufactured and prepared in this way. Note that a glass substrate was laminated as the other member on the ten sets of transparent conductive-film laminates.

(2) Resistance Evaluation of Transparent Conductive-Film Laminate

The above-mentioned five sets having the cycloolefin-based resin film as the base material sheet and the five sets having the polycarbonate-based resin film as the base material sheet were put into a humidity proof test machine at 60 degrees centigrade and at a relative humidity of 90% for ten days. Then, the surface conditions were inspected by eye. As for the five sets having the cycloolefin-based resin film as the base material sheet, only two sets had a slightly whitened adhesion layer. However, as for the five sets having the polycarbonate-based resin film as the base material sheet, all the adhesion layers of the five sets were whitened, and two sets among them also had a little whitened transparent conductive-film layer.

### Example 5

(1) Manufacture of Transparent Conductive-Film Laminate

A cycloolefin-based resin film having a thickness of 50 μm was used as the base material sheet, and on a surface thereof a transparent conductive-film layer made of indium tin oxide having a thickness of 200 nm was formed by a sputtering method. Ten sets of the sheets manufactured as described above were prepared. The cycloolefin-based resin film that was used had an in-plane direction retardation value of 5 nm or smaller and water vapor transmission rate of 1 g/(m²·24 h).

Among the prepared ten sets, five sets were processed as follows. The base material sheet was heated to 160 degrees centigrade so as to perform press forming, and hence the base material sheet was formed into a three-dimensional shape with the rising part of approximately 200 μm on the periphery.

On the other hand, a polycarbonate-based resin film having a thickness of 50 μm was used as the optically isotropic sheet, and a transparent conductive-film layer made of indium tin oxide having a thickness of 200 nm was formed by a sputtering method on a surface of the polycarbonate-based resin film. The polycarbonate-based resin film that was used had an in-plane direction retardation value of 20 nm or smaller and water vapor transmission rate of 10 g/(m²·24 h) or higher. The polyurethane adhesion layer having a thickness of 25 μm was formed by the screen printing on the polycarbonate-based resin film on which the transparent conductive-film layer was formed, and a glass substrate was laminated as the other member on the same. In this way, 10 sets of sheet laminates were prepared, each of which is constituted of the optically isotropic sheet, the transparent conductive-film layer, the adhesion layer, and the other member.

Next, a polyurethane adhesion layer having a thickness of 25 μm was sprayed and formed by painting on the transparent conductive-film layer on the transparent conductive-film layer for all the 10 sets of transparent conductive-film laminates.

As for the five sets having the base material sheet formed in a three-dimensional shape, the above-mentioned sheet laminates were glued to the flat inner surface of the base material sheets having three-dimensional shape so that the polycarbonate-based resin film side contacts with the same. The flat region of the base material sheet corresponded to the outer dimensions of the optically isotropic sheet, so that the side surfaces of the optically isotropic sheet and the adhesion layer formed thereon were covered with the rising part of the base material sheet.

As for the remaining five sets of base material sheets without three-dimensional shape, the above-mentioned sheet laminates were simply glued to the base material sheets so that the polycarbonate-based resin film side contacts with the same.

(2) Resistance Evaluation of Transparent Conductive-Film Laminate

The five sets having the base material sheet in three-dimensional shape and the five sets without three-dimensional shape were put into a humidity proof test machine at 60 degrees centigrade and at a relative humidity of 90% for ten days. Then, the surface conditions were inspected by eye. All the five sets having the base material sheet with three-dimensional shape had no abnormal findings. However, as for the five sets without three-dimensional shape, three sets among them had a substantially whitened adhesion layer at an edge portion.

### Example 6

(1) Manufacture of Transparent Conductive-Film Laminate

A cycloolefin-based resin film having a thickness of 50 μm was used as the base material sheet, and a transparent conductive-film layer made of indium tin oxide having a thickness of 200 nm was formed thereon by a sputtering method. The cycloolefin-based resin film that was used had an in-plane direction retardation value of 5 nm or smaller and water vapor transmission rate of 1 g/(m²·24 h). Further, a polyurethane adhesion layer having a thickness of 25 μm was formed by the screen printing on the cycloolefin-based resin film on which the transparent conductive-film layer is formed, and on the adhesion layer a polycarbonate-based resin film having a thickness of 50 μm was laminated as an optically isotropic sheet. The polycarbonate-based resin film that was used had an in-plane direction retardation value of 20 nm or smaller and water vapor transmission rate of 10 g/(m²·24 h) or higher. On the laminated polycarbonate-based resin film, a transparent conductive-film layer made of indium tin oxide having a thickness of 200 nm was formed by a sputtering method. Further, on the polycarbonate-based resin film on which the transparent conductive-film layer was formed, a polyurethane adhesion layer having a thickness of 25 μm was formed by the screen printing. Further on the same, a glass substrate was laminated as the other member. In this way, 10 sets of transparent conductive-film laminates were prepared, each of which was constituted of the base material sheet, the transparent conductive-film layer, the adhesion layer, the optically isotropic sheet, the transparent conductive-film layer, the adhesion layer, and the other member.

Next, five sets among the prepared 10 sets of transparent conductive-film laminates were processed by air pressure forming at a temperature of 150 degrees centigrade and 10 atmospheric pressure. The base material sheet was set to be larger than the outer dimensions of the optically isotropic sheet, and in the prepared 10 sets of transparent conductive-film laminates, the adhesion layer at the peripheral part of the base material sheet was not in contact with any other layer. However, as for the five sets that underwent the process by air pressure forming, the peripheral part of the base material sheet was processed into a three-dimensional shape and was adhered to the side surfaces of the upper optically isotropic sheet and the adhesion layer. As for the remaining five sets, the three-dimensional process by air pressure forming was not performed.

(2) Resistance Evaluation of Transparent Conductive-Film Laminate

The five sets having the base material sheet processed into a three-dimensional shape and the five sets without the three-dimensional process were put into a humidity proof test machine at 60 degrees centigrade and at a relative humidity of 90% for ten days. Then, the surface conditions were inspected by eye. All of the five sets having the base material sheet processed into a three-dimensional shape had no abnormal findings. However, as for the five sets without the three-dimensional process, all of them had a whitened adhesion layer. In particular, the edge portion of the adhesion layer was whitened, and one set among them also had a little whitened transparent conductive-film layer.

<Features>

(1)

Many plastic films having a low in-plane direction retardation value such as polycarbonate-based resin used conventionally for the base material sheet or the optically isotropic sheet 414 have high water vapor transmission rate so as to easily allow water vapor to transmit. Therefore, there is a problem in which the adhesion layer 413 (and also the transparent conductive-film layer 412, depending on conditions) is whitened by water vapor passing through the base material sheet or the optically isotropic sheet 414 made of polycarbonate-based resin or the like.

However, in the capacitive touch sensor 40 of the second embodiment, the water vapor transmission rate of the base material sheet 411 (plastic sheet) is 1 g/(m²·day·atm) or lower. Therefore, it is possible to prevent water vapor from entering the adhesion layer 413 or the transparent conductive-film layer 412 laminated on the base material sheet 411.

In particular, the adhesion layer excellent in adhesiveness and various resistances usually has a conspicuous problem of absorbing moisture and being whitened. Therefore, if an adhesive excellent in adhesiveness and various resistances is used, high effect can be exerted.

Both the optically isotropic sheet 414 made of polycarbonate-based resin and the base material sheet 411 made of cyclopolyolefin resin have an in-plane direction retardation value of 20 nm or smaller. Therefore, it is possible to prevent optical problems such as occurrence of color shading when emerging light 25 from the liquid crystal display apparatus 20 is viewed via the polarizing plate 21 such as sunglasses, as illustrated in FIG. 2, and optical problems in which a color viewed by the user becomes a color different from that of the light emerging from the liquid crystal display apparatus 20.

(2)

In the capacitive touch sensors 40 and 40A in which the peripheral processed part 411a of the base material sheet 411 covers side surfaces of the first and second adhesion layer 413, it is possible to prevent entry of water vapor from the side surface into the adhesion layer 413, so that the effect of preventing the adhesion layer 413 from being whitened can be improved.

### Third Embodiment

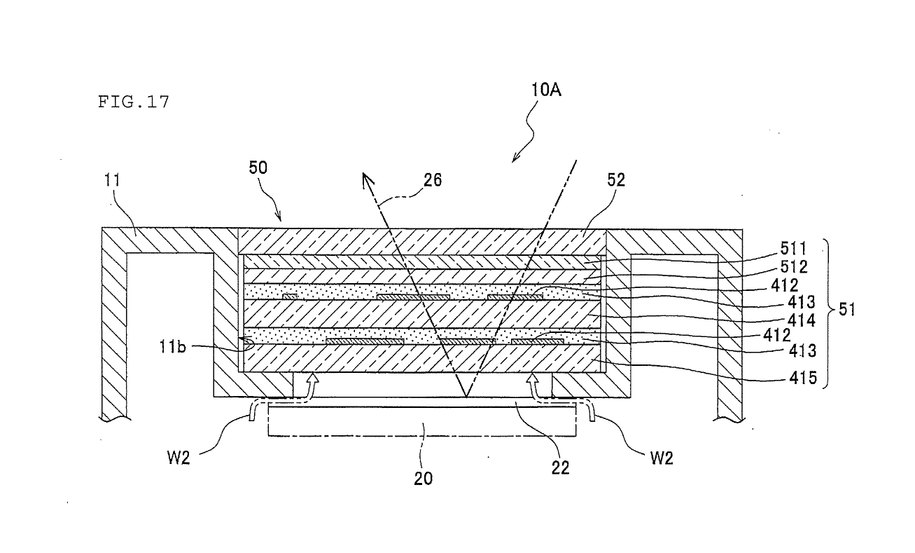

The capacitive touch sensor according to a third embodiment of the present invention is described with reference to FIG. 17. FIG. 17 is a partial cross sectional view of a cellular phone 10A. In FIG. 17, the same reference numerals or symbols as those in FIG. 2 denote the same parts as those in FIG. 2, and description thereof is omitted.

(1) Outline

The cellular phone 10A of FIG. 17 is different from the cellular phone 10 of FIG. 2 in the structures of a phase difference film 22 disposed on the liquid crystal display apparatus 20 and a capacitive touch sensor 50. The capacitive touch sensor 50 includes a transparent conductive-film laminate 51 and other member 52 illustrated in FIG. 17, and an FPC (not shown). The other member 51 may be a glass substrate, for example, and the FPC is connected to the transparent conductive-film layer 412 of the transparent conductive-film laminate 51 similarly to the FPC 30c illustrated in FIG. 1.

(2) Transparent Conductive-Film Laminate 51

(2-1) Outline of Structure

The transparent conductive-film laminate 51 includes the base material sheet 411, the transparent conductive-film layers 412, the adhesion layers 413, the optically isotropic sheet 414, a polarizing film 511, and a phase difference film 512. The transparent conductive-film laminate 51 has the same structure as the transparent conductive-film laminate 41C illustrated in FIG. 16 except for the polarizing film 511 and the phase difference film 512. Therefore, the polarizing film 511 and the phase difference film 512 are described, while descriptions of the base material sheet 411, the transparent conductive-film layer 412, the adhesion layer 413, and the optically isotropic sheet 414 are omitted.

The phase difference film 512 is laminated on the second adhesion layer 413, and the polarizing film 511 is laminated on the phase difference film 512. The other member 52 constituted of the glass substrate or the like is laminated on the polarizing film 511.

(2-2) Polarizing Film 511

The polarizing film 511 converts incident light into linearly polarized light. The polarizing film 511 may have a three-layered structure including dyed polyvinyl alcohol (PVA) and cellulose triacetate (TAC) serving as substrates supporting the dyed polyvinyl alcohol on both sides thereof, for example. It is preferred to use the polarizing film 511 having optical characteristics of a single transmittance of 40% or higher and a polarization degree of 99% or higher.

(2-3) Phase Difference Film 512

The phase difference film 512 is disposed closer to the optically isotropic sheet 414 than the polarizing film 511, so as to convert the linearly polarized light into circularly polarized light. It is preferred that the phase difference film 512 have a phase difference value of approximately 137 nm corresponding to ¼ of a wavelength of 550 nm at which human visual sensitivity is highest. The phase difference film 512 may be obtained by forming a film of polycarbonate resin (PC), polyarylate resin (PAR), or norbornene-based resin under a preset drawing condition so that a desired phase difference value is obtained. As the norbornene-based resin film, there exists a film of ARTON (registered trademark) manufactured by JSR Corporation or a film of ZEONOR (registered trademark) manufactured by ZEON CORPORATION.

### Variation Example 3-1

The transparent conductive-film laminate 51 of the above-mentioned embodiment shows a case where the transparent conductive-film layer 412 and the adhesion layer 413 are laminated by two layers each. However, as illustrated in FIG. 13, it is also possible to laminate these layers by one layer each. In addition, in the transparent conductive-film laminate 51, the side surface of the adhesion layer 413 is not covered with the peripheral processed part of the base material sheet 411. However, if the cellular phone 10 has low waterproofing property on the front side 11a, it is possible to adopt a structure in which the side surfaces of the adhesion layer 413, the polarizing film 511, and the phase difference film 512 are covered with the base material sheet 411 as illustrated in FIG. 10 or 13.

In addition, in the transparent conductive-film laminate 51 of the embodiment, the base material sheet 411 is made of cycloolefin-based resin having high water vapor barrier performance and low in-plane direction retardation value. However, in the same manner as the first embodiment, it is possible to use a combination of the protection sheet 311 and the base material sheet 312 instead of the base material sheet 411.

### Example 7

(1) Manufacture of Transparent Conductive-Film Laminate

In the transparent conductive-film layer sheet using the cycloolefin-based resin film of Example 1, between the glass substrate and the transparent conductive-film layer, there were formed a three-layered structure polarizing film having a thickness of 110 μm and optical characteristics including polarization degree of 99.5% and single transmittance of 43% (the structure including polyvinyl alcohol (PVA) having a thickness of 30 μm and cellulose triacetate (TAC) substrates having a thickness of 40 μm supporting the polyvinyl alcohol on both sides thereof), and a phase difference film containing polyarylate resin as a main component having a thickness of 70 μm and a phase difference value of 135 nm having an absorption axis inclined by approximately 45 degrees with respect to an absorption axis of the polarizing film, in this order.

(2) Resistance Evaluation of Transparent Conductive-Film Laminate

With this structure, the evaluation was performed similarly as that of Example 1. As a result, there was the effect of preventing the adhesion layer from being whitened, similar to the transparent conductive-film layer sheet using the cycloolefin-based resin film of Example 1. In addition, because the reflection of the transparent conductive-film layer 412 was suppressed more than the transparent conductive-film layer sheet of Example 1 using the cycloolefin-based resin film, the boundary of the pattern of the transparent conductive-film layer was hardly visible. Thus, the transparent conductive-film laminate was obtained, which is superior in resistance and can prevent a problem in which the pattern of the transparent conductive-film layer is visible, in comparison with the case of Example 1 without lamination of the protection sheet that was used.

<Features>

(1)

The transparent conductive-film laminate 51 of the third embodiment includes the structure of the transparent conductive-film laminate 41C of the second embodiment. Therefore, regarding prevention of whitening of the adhesion layer 413 and the transparent conductive-film layer 412, the same effect as the second embodiment can be obtained.

In addition, the same effect as the second embodiment can be obtained also regarding prevention of optical problems such as occurrence of color shading and optical problems in which a color viewed by the user becomes a color different from that of the light emerging from the liquid crystal display apparatus 20.

(2)

If the polarizing film 511 is disposed so as to have the same absorption axis as the polarizing plate of the liquid crystal display apparatus 20 disposed below the base material sheet 411, when the liquid crystal display apparatus 20 displays information, the emerging light 25 from a light source of the liquid crystal display apparatus 20 can pass through more.

Further, when the phase difference film 512 is disposed, reflection of light that has passed through the polarizing film 511 and the phase difference film 512 can be suppressed. Therefore, there is little reflection of the transparent conductive-film layer 412. As a result, it is possible to prevent the pattern of the transparent conductive-film layer 412 from being seen, and it is possible to prevent the information displayed on the liquid crystal display apparatus 20 from becoming difficult to view when the pattern of the transparent conductive-film layer 412 can be seen.

1. A capacitive touch sensor comprising:
a transparent plastic sheet;
a transparent conductive-film layer formed on the plastic sheet; and
a transparent adhesion layer formed on the transparent conductive-film layer so as to cover the transparent conductive-film layer, wherein
the plastic sheet has water vapor transmission rate of 1 g/(m²·day·atm) or lower and an in-plane direction retardation value of 20 nm or smaller at a wavelength of 550 nm.

2. The capacitive touch sensor according to claim 1, further comprising:
a phase difference film disposed on a side of the adhesion layer opposite to the plastic sheet; and
a polarizing film disposed on the phase difference film.

3. The capacitive touch sensor according to claim 1, wherein the plastic sheet includes:
a transparent plastic base material sheet having a surface on which the transparent conductive-film layer is formed, and an in-plane direction retardation value of 20 nm or smaller at a wavelength of 550 nm, and
a transparent protection sheet that is disposed on the other surface of the base material sheet and has water vapor transmission rate of 1 g/(m²·day·atm) or lower and an in-plane direction retardation value of 20 nm or smaller at a wavelength of 550 nm.

4. The capacitive touch sensor according to claim 3, wherein the protection sheet is formed of cycloolefin-based resin.

5. The capacitive touch sensor according to claim 4, wherein the base material sheet is formed of polycarbonate-based resin.

6. The capacitive touch sensor according to claim 3, wherein the protection sheet is formed in a three-dimensional shape so as to cover a side surface of the adhesion layer.

7. The capacitive touch sensor according to claim 1, wherein the plastic sheet is a transparent base material sheet having water vapor transmission rate of 1 g/(m²·day·atm) or lower and an in-plane direction retardation value of 20 nm or smaller at a wavelength of 550 nm.

8. The capacitive touch sensor according to claim 7, wherein the base material sheet is formed of cycloolefin-based resin.

9. The capacitive touch sensor according to claim 7, wherein the base material sheet is formed in a three-dimensional shape so as to cover a side surface of the adhesion layer.

10. The capacitive touch sensor according to claim 1, further comprising:
an optically isotropic sheet that is disposed on the adhesion layer and has an in-plane direction retardation value of 20 nm or smaller at a wavelength of 550 nm;
another transparent conductive-film layer formed on the optically isotropic sheet; and
another transparent adhesion layer formed on the another transparent conductive-film layer.

11. An electronic device comprising:
a case;
a display apparatus disposed in the case; and
the capacitive touch sensor according to claim 1 disposed on the display apparatus in the case.

12. A method of manufacturing a transparent conductive-film laminate, comprising:
a step of disposing a transparent base material sheet having an in-plane direction retardation value of 20 nm or smaller at a wavelength of 550 nm on a transparent plastic protection sheet having water vapor transmission rate of 1 g/(m²·day·atm) or lower and an in-plane direction retardation value of 20 nm or smaller at a wavelength of 550 nm;
a conductive-film layer forming step of forming a transparent conductive-film layer on the base material sheet;
an adhesion layer forming step of forming a transparent adhesion layer on the transparent conductive-film layer so as to cover the transparent conductive-film layer; and
a side surface covering step of covering a side surface of the adhesion layer with the protection sheet.

13. The method of manufacturing a transparent conductive-film laminate according to claim 12, further comprising a forming step of forming the protection sheet into a three-dimensional shape before the side surface covering step.

14. A method of manufacturing a transparent conductive-film laminate, comprising:
a conductive-film layer forming step of forming a transparent conductive-film layer on a transparent plastic base material sheet having water vapor transmission rate of 1 g/(m²·day·atm) or lower and an in-plane direction retardation value of 20 nm or smaller at a wavelength of 550 nm;
an adhesion layer forming step of forming a transparent adhesion layer on the transparent conductive-film layer so as to cover the transparent conductive-film layer; and
a side surface covering step of covering a side surface of the adhesion layer with the base material sheet.

15. The method of manufacturing a transparent conductive-film laminate according to claim 14, further comprising a forming step of forming the base material sheet into a three-dimensional shape before the side surface covering step.

16. The capacitive touch sensor according to claim 2, wherein the plastic sheet includes:
a transparent plastic base material sheet having a surface on which the transparent conductive-film layer is formed, and an in-plane direction retardation value of 20 nm or smaller at a wavelength of 550 nm, and
a transparent protection sheet that is disposed on the other surface of the base material sheet and has water vapor transmission rate of 1 g/(m²·day·atm) or lower and an in-plane direction retardation value of 20 nm or smaller at a wavelength of 550 nm.

17. The capacitive touch sensor according to claim 4, wherein the protection sheet is formed in a three-dimensional shape so as to cover a side surface of the adhesion layer.

18. The capacitive touch sensor according to claim 2, wherein the plastic sheet is a transparent base material sheet having water vapor transmission rate of 1 g/(m²·day·atm) or lower and an in-plane direction retardation value of 20 nm or smaller at a wavelength of 550 nm.

19. The capacitive touch sensor according to claim 8, wherein the base material sheet is formed in a three-dimensional shape so as to cover a side surface of the adhesion layer.

20. The capacitive touch sensor according to claim 2, further comprising:
an optically isotropic sheet that is disposed on the adhesion layer and has an in-plane direction retardation value of 20 nm or smaller at a wavelength of 550 nm;
another transparent conductive-film layer formed on the optically isotropic sheet; and
another transparent adhesion layer formed on the another transparent conductive-film layer.
